(19) United States
(12) Patent Application Publication
(10) Pub. No.: US 2002/0136490 A1
(43) Pub. Date: Sep. 26, 2002

(54) MEMS optical switch including tapered fiber with hemispheric lens

(76) Inventors: Nan Zhang, Chanhassen, MN (US); Souksamay Chounlamontry, Maplewood, MN (US); Susan Bromley, Eden Prairie, MN (US)

Correspondence Address: MERCHANT & GOULD PC, P.O. BOX 2903, MINNEAPOLIS, MN, 55402-0903, US

(21) Appl. No.: 09/769,007

(22) Filed: Jan. 24, 2001

(51) Int. Cl. G02B 6/32; G02B 6/26; G02B 6/255

(52) U.S. Cl. 385/33; 385/43; 385/96

(57) ABSTRACT

A method of fabricating a tapered fiber having a hemispheric end i.e. TH fiber, is provided. The TH fiber has high coupling efficiency and low coupling loss, while providing good reproducibility and ease of fabrication. The TH fiber is adapted for MEMS-based switch applications. Also, a method of measuring a beam profile of a fiber is provided. The beam profile measuring technique allows for easy control and manipulation of the fabrication process of the TH fiber.

### FIELD OF THE INVENTION

The present invention relates to optical switches and, more particularly, to microelectromechanical (MEMS) optical switches using a tapered fiber and fabrication of a tapered fiber.

### BACKGROUND OF THE INVENTION

Photonic devices, such as MEMS-based optical switches, are inherently sensitive to fiber alignment parameters including axial, transverse, and angular displacements. These displacements can be induced mechanically or thermally. By using beam expansion optics, these alignment problems can be alleviated. In beam expansion approaches, discrete components, such as spherical, GRIN, or cylindrical lenses, or combinations of these lenses, are used to increase a single-mode spot size and to reduce sensitivity to alignment parameters. These discrete elements, however, introduce problems of their own. They require critical and difficult alignment which must remain stable. In addition, they possess aberrations which limit performance. Moreover, for MEMS-based switch applications, a beam diameter of a conventional microball lens and collimators, is generally larger than 50 μm, which is too large for micro-mirror design requirements. One exception involves using a built-on-chip silicon or silica waveguide expander which can yield 30 μm beam spot diameter at 1310 nm wavelength. However, this waveguide expander is strongly wavelength dependent and exhibits high loss because it uses an optical diffraction mechanism, and it is not suitable for DWDM (Dense Wavelength Division Multiplexing) network interconnection.

Tapered fiber has frequently been used for interconnection of photonic devices, such as for coupling a laser beam from a laser diode to a single-mode fiber. This coupling technique is attractive because of the relative ease of fiber fabrication, reasonable coupling efficiency, and reduced influence of reflected light. Typically, the etching process uses HF solution but that has proven to be troublesome and the etching process can make the fiber fragile.

For MEMS optical switches, it is desirable to have a tapered fiber with high coupling efficiency, misalignment tolerant, low coupling loss, and low back reflection. Also, it is desirable that optimal separation, i.e. a distance between launching and receiving fibers where the coupling loss is a minimum, is in a workable range for assembly. Shorter distances would be difficult for assembly and can easily damage optical lens or mirror, etc., whereas longer distances would cause additional insertion loss and material waste. In addition, it is desirable that a beam diameter created by a tapered fiber can be smaller than 30 μm to ensure that there is no light scattering and crosstalk, due to light hitting an edge of a mirror or passing over it. It is further desirable that a tapered fiber is tolerant to misalignment during an assembly process.

One technique of processing a tapered fiber was proposed by Kuwahara, et al., in his article entitled “Efficient coupling from semiconductor lasers into single-mode fibers with tapered hemispherical ends”, Appl. Opt. vol. 19, no. 15, pp. 2578-2583, Aug. 1, 1980. In this technique, a tapered fiber with a hemispherical end, i.e. TH fiber, is fabricated by drawing/tapering a fiber in an arc discharge of an arc welder. In the tapered region of the TH fiber, the thickness of the core and cladding decreases. The hemispherical tip of the fiber is produced by surface tension of the molten glass, and the tip of the TH fiber is covered with cladding glass. However, due to the use of arc splicing, the resulting tapered fiber is not uniform in terms of a ratio of the cladding and the core of the fiber, particularly at the tapered region. Often time, the arc splicing forms different shapes of cladding and core, other than a round shape of cladding and core. For example, sometimes the arc splicing forms an ellipse shape of cladding and core. These distortions caused by the arc splicing have significantly increased the insertion loss between the cladding and the core. Further, because it is difficult to control the arc discharge, the reproducibility of such tapered fiber is typically low. This technique does not allow easy control of the fiber geometry, such as fiber cladding/core diameters, tapered angle, fiber coupling separation length (or referred to as “Raleigh range”), fiber alignments (e.g. axial, transversal, and angular misalignment), fiber optical beam profile, etc. These and other deficiencies are not desirable in fabricating a fiber for MEMS-based switch applications.

Therefore, improvements on fiber fabrication, particularly for MEMS-based switch applications, are desired.

### SUMMARY OF THE INVENTION

One aspect of the present invention relates to a method of fabricating a tapered fiber with a hemispherical end, i.e. TH fiber. In one embodiment, the method includes the steps of splicing a fiber by heating the fiber, tapering the spliced fiber by pulling the spliced fiber with a first predetermined speed and/or temperature to form two tapered fibers, and lensing the tapered fiber by setting the fiber back to be heated with a second predetermined speed and/or temperature to form a hemispherical end for each of the tapered fiber.

Further in one embodiment, the method includes the steps of providing a pair of filaments which are aligned and adjacent to each other, and placing a fiber in each of the filaments. The step of splicing the fiber includes heating the two filaments to form the two fibers into one fiber.

Still in one embodiment, the method includes the steps of changing the first predetermined speed and/or temperature, and repeating the splicing step, the tapering step, and the lensing step.

Yet in one embodiment, the method includes the steps of changing the second predetermined speed and/or temperature, and repeating the splicing step, the tapering step, and the lensing step.

Another aspect of the present invention relates to a tapered fiber with a hemispherical end (i.e. TH fiber) adapted for MEMS-based switch applications. The tapered fiber includes a longitudinal member having a cladding portion and a core portion, and a tapered member having a cladding portion and a core portion, a ratio of the cladding portion and core portion of the tapered member being uniform. The tapered member has a hemispherical end being formed by surface tension of molten glass and covered by molten glass.

A further aspect of the present invention relates to a system of fabricating a tapered fiber with a hemispherical end adapted for MEMS-based switch applications. The system includes a pair of filaments, a pair of fibers disposed in the filaments, respectively, the fibers being spliced into one fiber by heating the filaments, tapered into two tapered fibers by pulling the spliced fiber with a first predetermined speed and/or temperature, and lensed by setting the tapered fibers back to the heated filaments with a second predetermined speed and/or temperature so as to form the hemispherical end for each of the tapered fiber. The tapered fibers have a uniform ratio of cladding portion and core portion.

Still another aspect of the present invention relates to a method of measuring a beam profile of a launching fiber with a hemispherical end (i.e. TH fiber). The method includes the steps of providing a receiving fiber aligned with the launching fiber, turning on a light source to send optical beams to the launching fiber, pulling the receiving fiber away from/toward the launching fiber in a horizontal axis, a transversal axis, and/or a vertical axis, respectively, and detecting received optical beams at the receiving fiber. In one embodiment, the receiving fiber has a narrower core than the launching fiber.

A further aspect of the present invention relates to a system of measuring a beam profile of a launching fiber. The system includes a light source to send optical beams to the launching fiber, the launching fiber being coupled to the light source, a receiving fiber to receive optical beams from the launching fiber, the receiving fiber being disposed aligned with the launching fiber, and a detector to detect the received optical beams at the receiving fiber while the receiving fiber is being pulled away from/pushed toward the launching fiber in a horizontal axis, a transversal axis, and/or a vertical axis, respectively. In one embodiment, the receiving fiber has a narrower core than the launching fiber.

One of the advantages of the present invention is that it provides a tapered fiber with a tapered fiber with high coupling efficiency, high misalignment tolerant, low coupling loss, and low back reflection, while providing good reproducibility and ease of fabrication, which are desirable for MEMS-based switch applications. Another advantage of the present invention is that it provides a novel method of measuring a beam profile of a fiber that allows control and manipulation of the fabrication process of a TH fiber.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 is a flow diagram of a method of fabricating a tapered fiber with a hemispherical end, i.e. TH fiber, in accordance with the principles of the present invention.

FIG. 2 is a schematic view of one embodiment of a filament in accordance with the principles of the present invention.

FIGS. 3-7 are schematic views of a system of fabricating the TH fiber adapted for MEMS-based switch applications in accordance with the principles of the present invention.

FIG. 8A is a photographic view of the TH fiber while the fiber is being tapered in accordance with the principles of the present invention.

FIG. 8B is a photographic view of the TH fiber after the fiber is lensed in accordance with the principles of the present invention.

FIG. 9 is schematic view of a lens shape of the TH fiber in accordance with the principles of the present invention.

FIG. 10 illustrates in a schematic view the geometry tolerant of the TH fiber in accordance with the principles of the present invention.

FIG. 11 is a flow diagram of a method of measuring a beam profile of the TH fiber in accordance with the principles of the present invention.

FIG. 12 is a block diagram of a system of measuring a beam profile of the TH fiber in accordance with the principles of the present invention.

FIG. 13 is a schematic view of relative intensity of the TH fiber as a function of beam diameter while the fiber is measured in different positions between a receiving fiber and the tip of the TH fiber in accordance with the principles of the present invention.

FIG. 14 is a schematic view of beam radius of the TH fiber as a function of the distance from the tip of the TH fiber in accordance with the principles of the present invention.

FIG. 15 is a 3-D schematic view of Gaussian beam profile of the TH fiber in accordance with the principles of the present invention.

FIG. 16 is a photographic view of light distribution from the tip of the TH fiber in accordance with the principles of the present invention.

FIG. 17 is a photographic view of light distribution from the tip of a conventional flat-end fiber.

FIG. 18 is a schematic view of the coupling loss measured from TH fibers with different wavelengths in accordance with the principles of the present invention.

FIG. 19 illustrates three types of fiber misalignments/offsets.

FIG. 20 is a schematic view of the coupling loss as a function of transversal misalignment of a fiber.

FIG. 21 is a schematic view of the coupling loss as a function of axial misalignment of a fiber.

### DETAILED DESCRIPTION OF THE PREFERRED EMBODIMENT

The present invention provides for a tapered fiber with high coupling efficiency and low coupling loss, while providing good reproducibility and ease of fabrication, which are desirable for MEMS-based switch applications. The present invention also provides a method of fabricating a tapered fiber and a system and method of measuring a beam profile of a fiber that allows control and manipulation of the fabrication process of a TH fiber.

In the following description of the preferred embodiments, reference is made to the accompanying drawings, which form a part hereof, and in which is shown by way of illustration several embodiments in which the invention may be practiced. It is to be understood that other embodiments may be utilized as structural changes and may be made without departing from the spirit and scope of the present invention.

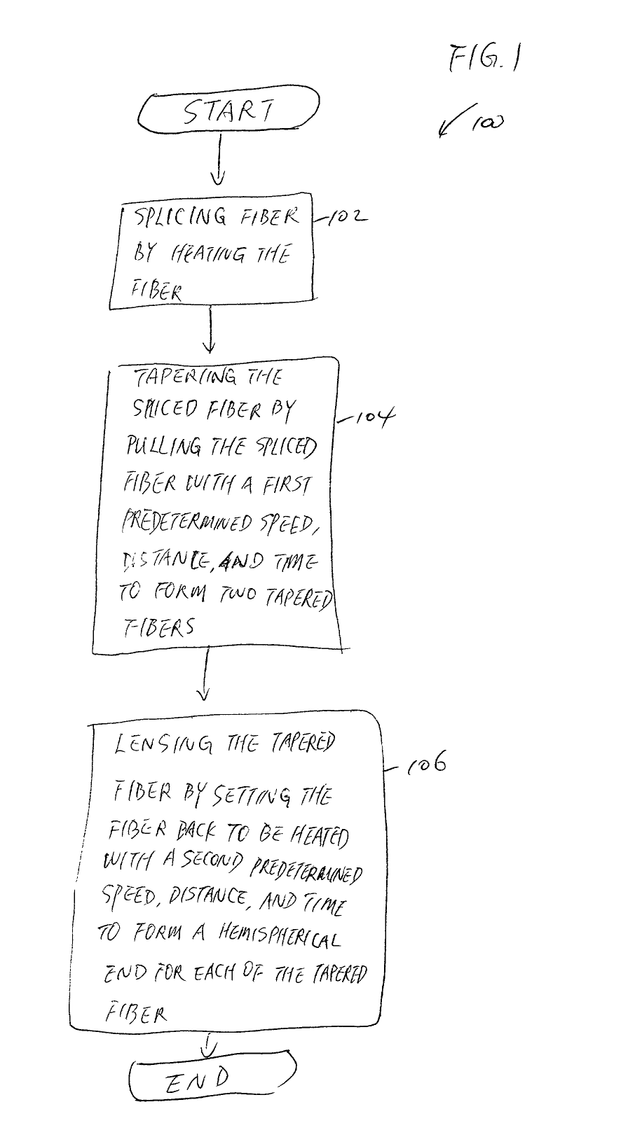

Now referring to FIG. 1, a process 100 of fabricating a tapered fiber with a hemispherical end, i.e. TH fiber, in accordance with the principles of the present invention is illustrated. The process 100 starts with an operation 102 of splicing a fiber by heating the fiber. Next, the spliced fiber is tapered by pulling the spliced fiber with a first predetermined speed and/or temperature to form two tapered fibers in an operation 104. Then, a hemispherical end is formed by setting the fiber back to be heated with a second predetermined speed and/or temperature in an operation 106.

It is appreciated that other steps may be performed in the process 100. For example, the process 100 may include steps of changing the first and/or second predetermined speed and/or temperature, and repeating the splicing step, the tapering step, and the lensing step.

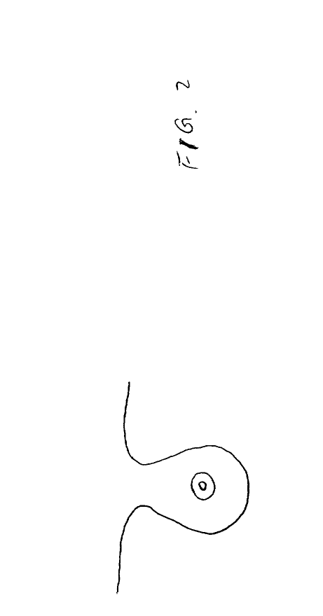

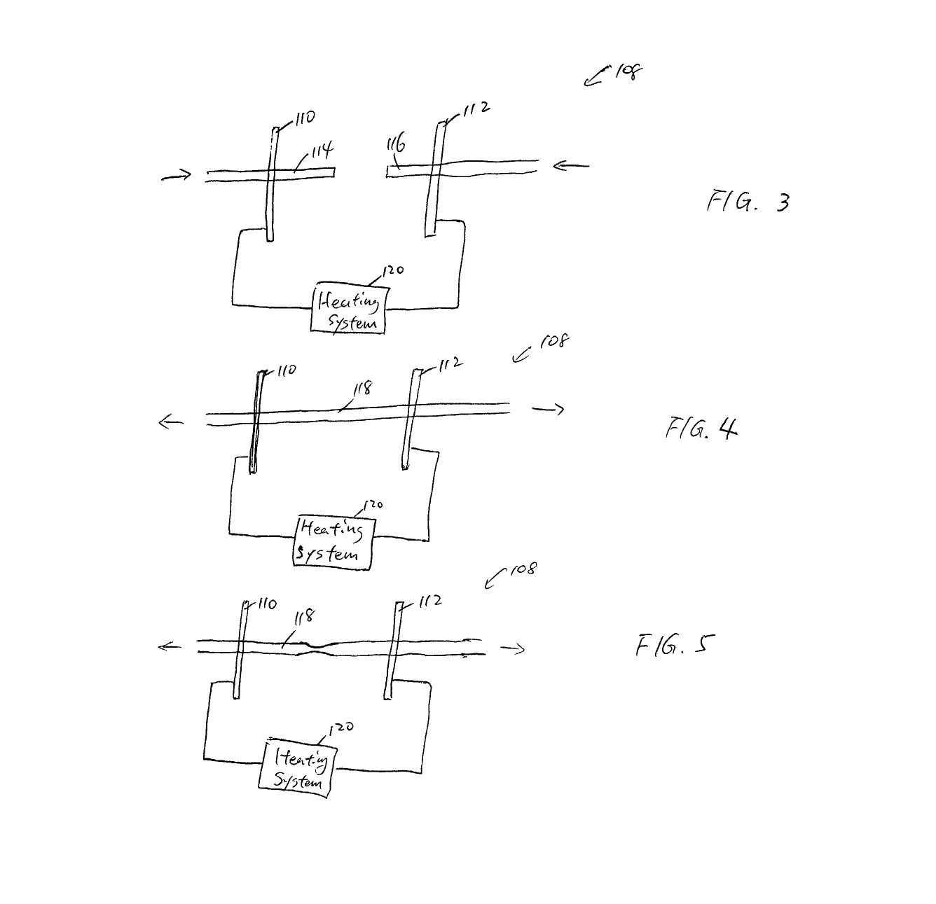

FIG. 2 illustrates one embodiment of a filament in accordance with the principles of the present invention. FIGS. 3-7 illustrate a side view of the filament. Generally, a filament is a material that can be heated by a heating system and creates a heating zone. The filament as shown creates a heating zone for a fiber to be heated therein. The fiber is preferably placed in the center of the heating zone.

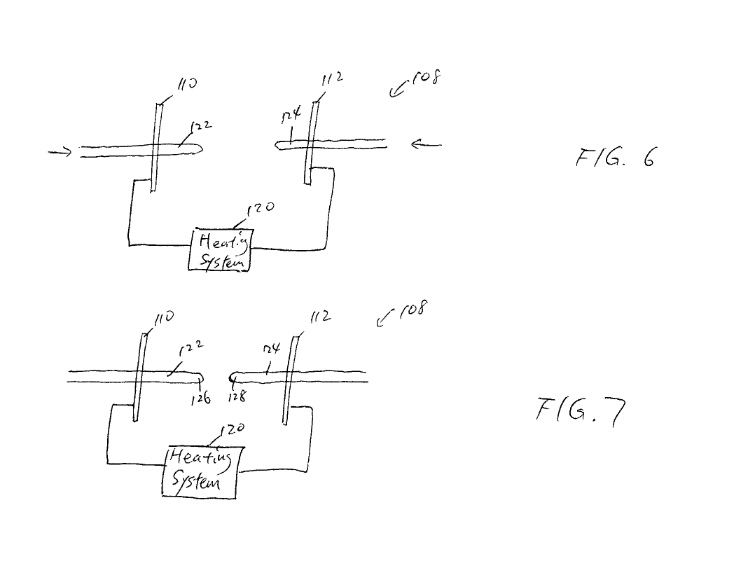

In FIGS. 3-7, a system 108 of fabricating a TH fiber in accordance with the principles of the present invention is illustrated. The system 108 includes a pair of filaments 110, 112 which are coupled to a heating system 120. A pair of fibers 114, 116 are placed in the filaments 110, 112, respectively (FIG. 3). The two fibers 114, 116 are spliced into one fiber 118 (FIG. 4) by heating the filaments 110, 112. The temperature of the heating system is controlled in a conventional manner. The fiber 118 is then tapered into two tapered fibers 122, 124 by pulling the spliced fiber 118 with a first predetermined speed and/or temperature (FIGS. 5 and 6). Next, the tapered fibers 122, 124 are lensed by setting the tapered fibers 122, 124 back to the heated filaments 110, 112 with a second predetermined speed and/or temperature so as to form a hemispherical end 126, 128 for each of the tapered fibers 122, 124 (FIG. 7). The mechanism for moving the fibers out of the filaments 110, 112 and for setting the fibers 122, 124 back into the filaments 110, 112 can be performed by any conventional mechanism. The speed of setting the fibers back and the temperatures of the filaments are appropriate such that each of the tapered fibers has a uniform ratio of cladding portion and core portion.

The setback steps are preferably in a range of about 62.5 μm-225 μm, or about 500-1,800 steps, and more preferably about 187.5 μm, or about 1,500 steps. Each step is about 0.125 μm. The tapering speed is preferably about 1,000 steps/second. The setback speed is preferably in a range of about 500-1,000 steps/second, and more preferably about 900 steps/second. The filament temperature is preferably in a range of about 1,800° C.-2,200° C., and more preferably about 2,150° C.

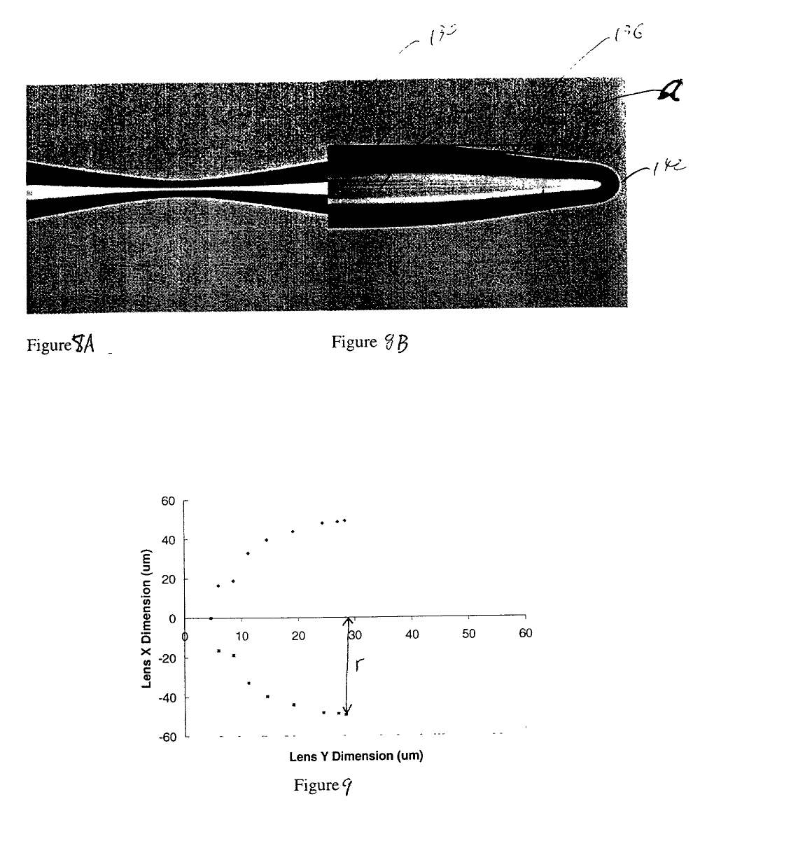

FIGS. 8A and 8B illustrate photographic views of a TH fiber while the fiber is being tapered and the TH fiber after the fiber is lensed, respectively. A tapered fiber is broken into two fibers in a tapering process. During a lensing process, the tapered end of each fiber is formed into a hemispherical end. As shown, the fiber with the hemispherical end has a longitudinal member 130 having a cladding portion 132 and a core portion 134, and a tapered member 136 having a cladding portion 138 and a core portion 140. A thickness ratio of the cladding portion 138 and the core portion 140 of the tapered member 136 is uniform. A hemispherical end 142 is formed by surface tension of molten glass and covered by the molten glass. Generally, the molten glass includes both the cladding glass and the core glass. In one implementation, a TH fiber can be processed by Vytran FFS-2000 Automated Fusion Splicing workstation. It is appreciated that other fusion splicing systems can be used within the scope of the present invention.

In one embodiment, the filament size is preferably 0.23 inch×0.15 inch. The fibers are preferably single-mode Coming SMF-28 fibers with parameters listed in the following table:

| | |
|---|---|
| Core diameter | 8.3 μm |
| Cladding diameter | 125.0 +/− 1.0 μm |
| Core-Clad Concentricity | less than or equal to 0.5 μm |
| Cladding Non-Circularity* | less than or equal to 1.0% |
| Numerical Aperture | 0.13 |
| Refractive Index Difference | 0.36% |
| Cutoff Wavelength | less than 1260 nm |
| Mode-Field Diameter | 8.0 to 9.80 μm at 1310 nm; |
| | 9.50 to 11.50 at 1550 nm |

*Defined as [1-Min. Cladding Diameter/Max. Cladding Diameter] × 100.

In the tapered region of the fiber, the taper length is preferably in a range of about 100 μm to about 500 μm, and more preferably about 458 μm. The lens radius preferably ranges from about 23 μm to about 56 μm, and more preferably about 48 μm. The narrowest core radius is preferably about 4 μm. The taper out-cladding pulling angle α (FIG. 8B) is preferably in the range of about 10° to about 30°, and more preferably about 16.2°. The filament power is preferably in the range of about 14.6 W to about 17 W. Increasing the filament power creates a lens having a larger radius because more molten glasses are formed at the hemispherical end. Also, the more setback steps or distance, the more heat the tapered portion is getting, and the larger the lens radius. It is noted that the setback steps or distance is limited, i.e. the lens diameter does not increase anymore when setback steps reach to a certain amount at a particular filament power. This is because filaments are not able to melt anymore materials at a higher power contributed to the formation of lens. The following table is the variable lenses fabricated under different lens finish condition:

| | | Setback Steps | |
|---|---|---|---|
| Groups | Power (W) | (1 step = 0.125 μm) | Lens Diameter (μm) |
| I | 14.6 | 1300 | 31.5 |
| | 14.6 | 1100 | 30.87 |
| | 14.6 | 800 | 29.61 |
| | 14.6 | 500 | 23.31 |
| II | 16.5 | 1100 | 42.84 |
| | 16.5 | 1500 | 46.62 |
| | 16.5 | 1700 | 49.14 |
| | 16.5 | 1800 | 50.4 |
| III | 14.6 | 1100 | 30.87 |
| | 15.75 | 1100 | 34.65 |
| | 16.5 | 1100 | 42.84 |
| IV | 15.75 | 1500 | 50.00 |
| | 16.5 | 1500 | 46.62 |
| | 17 | 1500 | 55.44 |

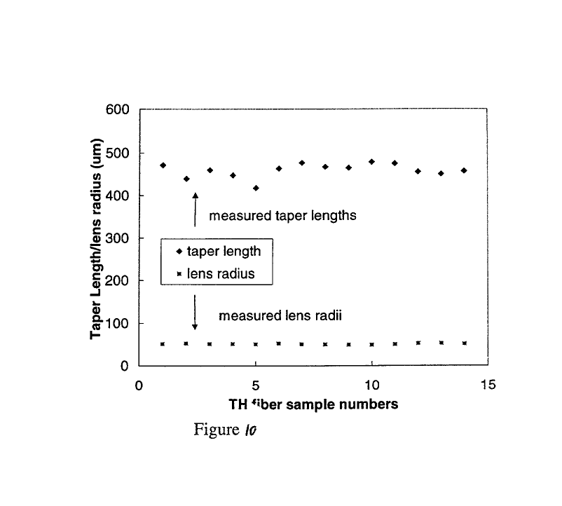

In FIG. 9, one embodiment of a lens shape of a TH fiber is illustrated. The lens radius r is about 48 μm.

FIG. 10 shows the geometry tolerant measurements of a TH fiber formed in accordance with the principles of the present invention. It is shown that once conditions such as the filament dimension, setback steps, and heat power, are set constant, the reproducibility of both the radius of the hemispheric end and taper dimensions is very good. In the preferred embodiment, the measured lens radii remain at about 48 μm, and the measured taper lengths remain in the vicinity of 450 μm. The tolerance for the lens radius is about 1 μm, and the tolerance for the taper length is about 16 μm. It is appreciated that other parameters may also impact reproducibility, such as the filament shape and the heating zone that the filaments are placed in, etc. The filament preferably has a round shape, and the filaments are preferably placed in the center of the heating zone.

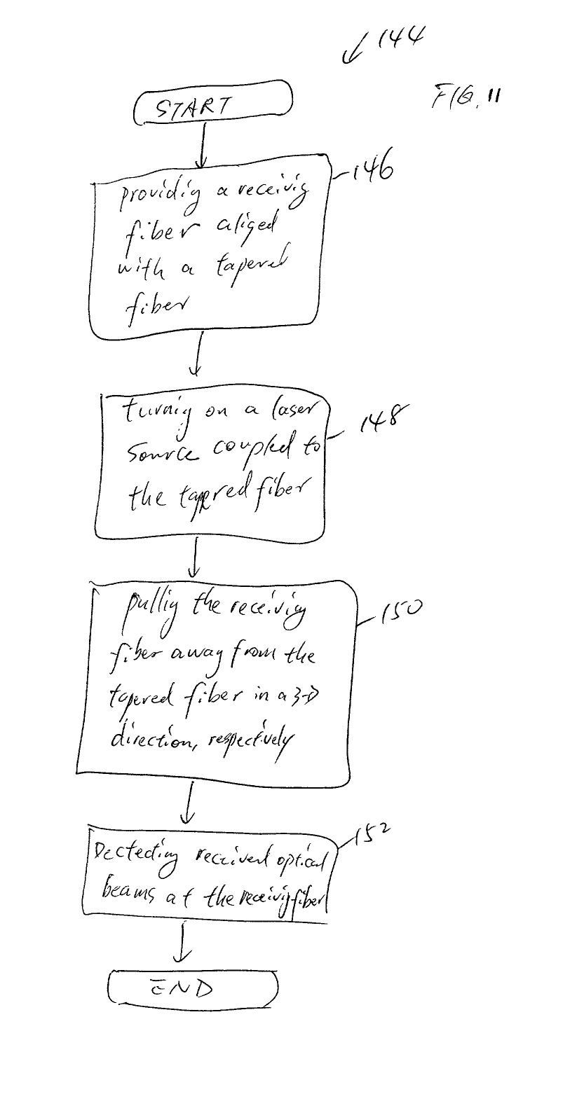

FIG. 11 illustrates one embodiment of a process 144 of measuring a beam profile of a fiber in accordance with the principles of the present invention. The process 144 starts with an operation 146 of providing a receiving fiber that is aligned with a fiber to be measured. Next, in operation 148, a light source, e.g. a laser source, which is coupled to the fiber to be measured, is turned on. Since optical beams are launched from the fiber to be measured, this fiber is referred to as a launching fiber. Then, in operation 150, the receiving fiber is moved toward and/or pulled away from the launching fiber in a 3D direction, i.e. x-y-z axis as shown. Then, the received optical beams at the receiving fiber are measured in an operation 152.

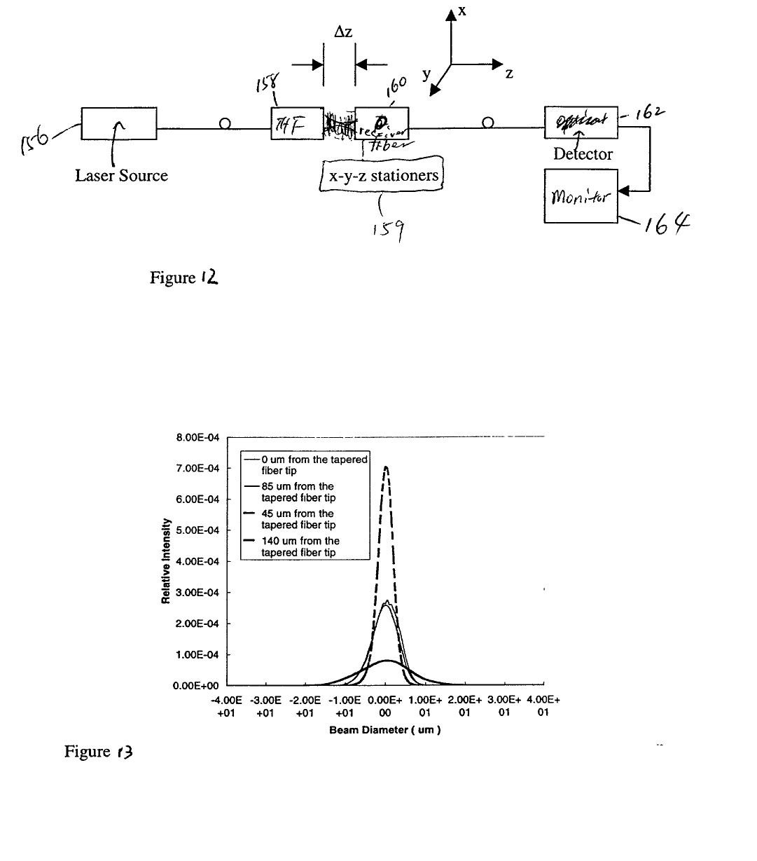

FIG. 12 illustrates a system 154 for measuring a beam profile of a fiber in accordance with the principles of the present invention. The system 154 includes a light source 156 for sending optical beams to a launching fiber 158. The launching fiber 158 is coupled to the light source 156. A receiving fiber 160 receives the optical beams from the launching fiber 158. The receiving fiber 160 is disposed aligned with the launching fiber 158 and preferably has a narrower core than the launching fiber 158. A detector 162 detects the received optical beams at the receiving fiber 160 while the receiving fiber 160 is being moved toward and/or pulled away from the launching fiber 158 in a horizontal axis, a transversal axis, and/or a vertical axis by an x-y-z station 159. The beam profile can be displayed on a monitor 164. The light source is preferably a laser source with a wavelength of about 1299.4 nm or about 1553 nm. The launching fiber is preferably a TH fiber.

FIG. 13 illustrates a beam profile for a TH fiber. As shown, the relative intensity of the TH fiber is a function of beam diameter. The four curves are measured at four different positions between the receiving fiber and the tip of the launching fiber. It is appreciated that coupling efficiency of two TH fibers can be measured in a similar manner, i.e. a beam profile of one of the TH fibers is measured while the other TH fiber is being used as a receiving fiber.

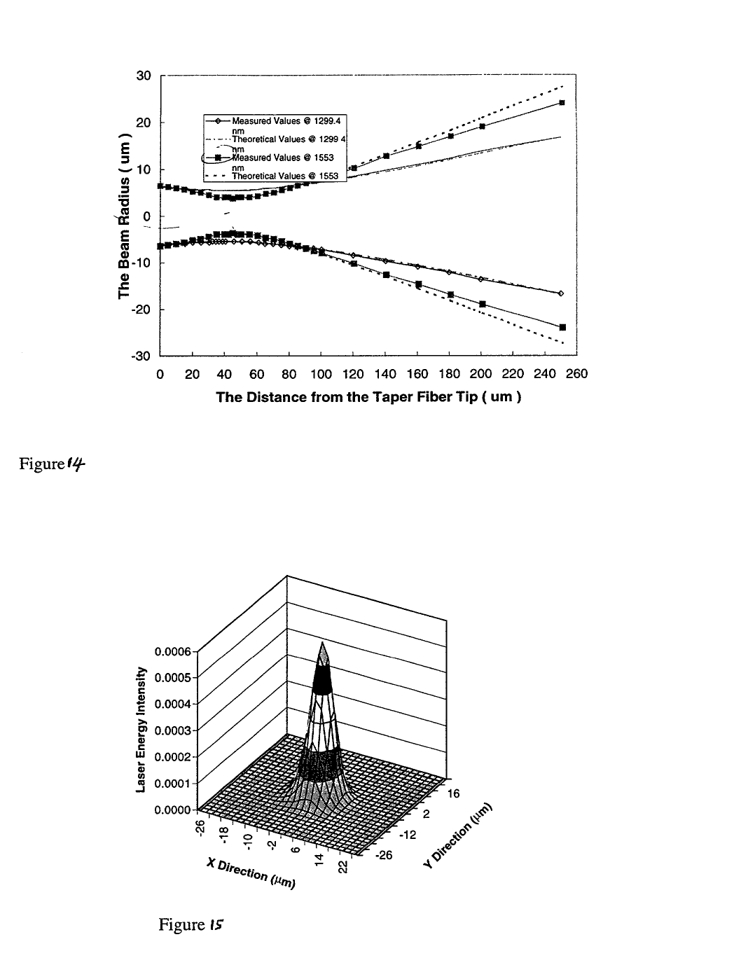

FIG. 14 illustrates beam radius of a TH fiber as a function of the distance from the tip of the TH fiber in accordance with the principles of the present invention. For a 1553 nm beam profile, the receiving fiber is preferably 3M® low-field mode single-mode fiber. The numerical aperture is 0.26 and the core diameter is 4.3 μm. The measured beam is a Gaussian beam with a beam waist of 5.3 μm. For a 1299.4 nm beam profile, the receiving fiber is Coming single-mode fiber SMF-28 with a core diameter of 8.3 μm. The measured beam is a Gaussian beam with a beam waist of 7.7 μm. In general, the larger the beam curvature, the more divergent the light. Since the beam curvature is proportional to the wavelength, the 1553 nm light gets a larger light scattering than the 1299.4 nm light. The focal point, i.e. a point that beams converge, is at 45.2 μm from the tip of the TH fiber for 1553 nm and 38.6 μm from the tip of the TH fiber for 1299.4 nm. The Raleigh Range is 18.08 μm for 1553 nm and 46.46 μm for 1299.4 nm. FIG. 15 shows a 3-D schematic view of Gaussian beam profile of a 1553 nm TH fiber.

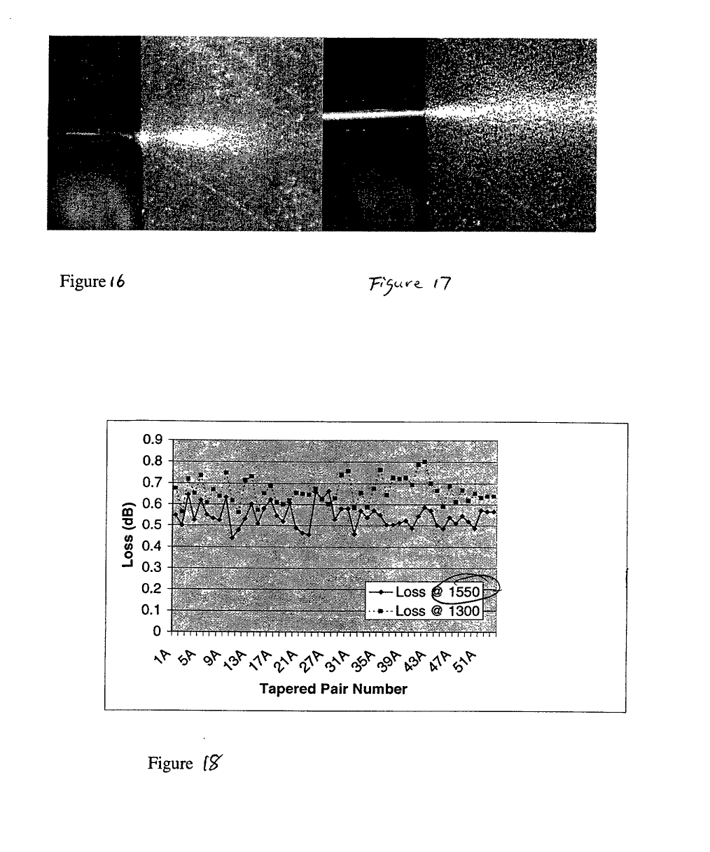

FIG. 16 is photographic view of the light distribution of a TH fiber in accordance with the principles of the present invention, and FIG. 17 is a photographic view of the light distribution of a conventional flat-end fiber. It is clear that with a TH fiber, after the light or beam leaves the fiber, the divergent light converges at a location that is about 40-60 μm away from its tip. After that, the light diverges. With a flat-end fiber, after the light leaves the fiber, the light diverges quickly, and there is no focal point captured during the light propagation. These are consistent with the beam profile measurement as described above.

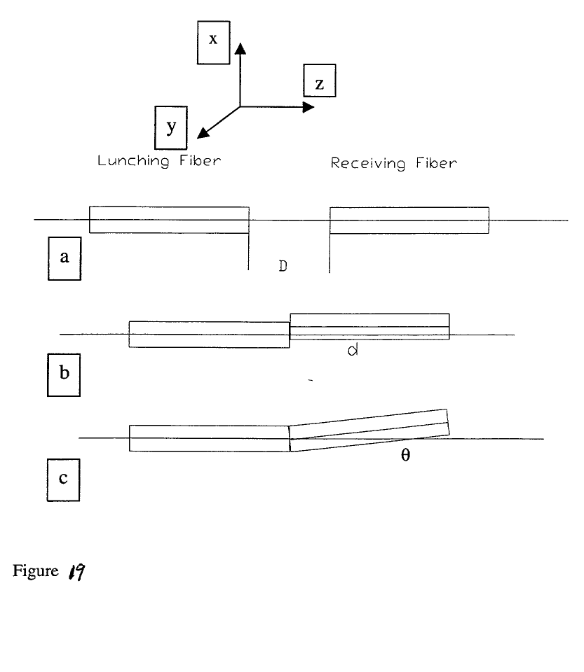

FIG. 18 illustrates the coupling loss measured from different TH fibers having different wavelengths in accordance with the principles of the present invention. It can be seen that the coupling loss of both TH fibers, i.e. a 1550 nm fiber and a 1300 nm fiber, is within the range of 0.45 dB to 0.8 dB. This range is very low in comparison with the coupling loss of the existing tapered fiber using the arc splicing technique which is disclosed by Kuwahara, et al., entitled “Efficient coupling from semiconductor lasers into single-mode fibers with tapered hemispherical ends”, Appl. Opt. vol. 19, no. 15, pp. 2578-2583, Aug. 1, 1980. The Kuwahara's coupling loss ranges from 4.1 dB to 6.2 dB.

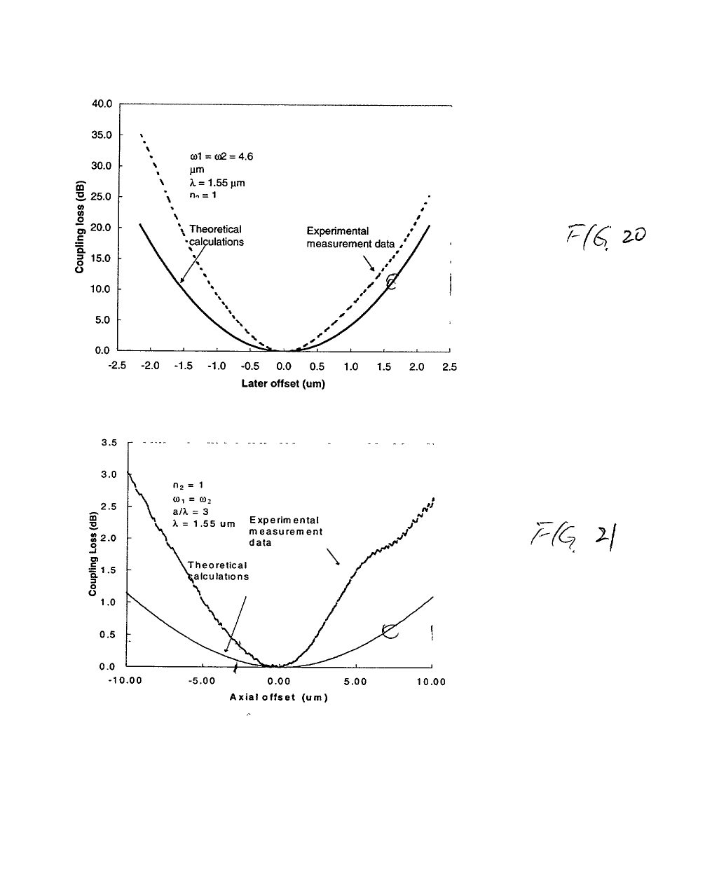

One type of coupling loss is caused by misalignment between a launching fiber and a receiving fiber. FIG. 19 illustrates three different fiber misalignments between a launching fiber and a receiving fiber. FIGS. 20 and 21 illustrate an exemplary coupling loss caused by the transversal misalignment and axial misalignment as shown in FIG. 19.

Having described the present invention in a preferred embodiment, modifications and equivalents may occur to one skilled in the art. It is intended that such modifications and equivalents shall be included within the scope of the claims which are appended hereto.

What is claimed is:

1. A method of fabricating a tapered fiber with a hemispherical end, comprising the steps of:
splicing a fiber by heating the fiber;
tapering the spliced fiber by pulling the spliced fiber with a first predetermined speed and temperature to form two tapered fibers; and
lensing the tapered fiber by setting the fiber back to be heated with a second predetermined speed and temperature to form a hemispherical end for each of the tapered fiber.

2. The method of claim 1, further comprising the steps of:
providing a pair of filaments which are aligned and adjacent to each other;
placing a fiber in each of the filaments; and
wherein the step of splicing the fiber includes heating the two filaments to form the two fibers into one fiber.

3. The method of claim 1, further comprising the steps of:
changing the first predetermined speed and temperature; and
repeating the splicing step, the tapering step, and the lensing step.

4. The method of claim 2, further comprising the steps of:
changing the first predetermined speed and temperature; and
repeating the splicing step, the tapering step, and the lensing step.

5. The method of claim 1, further comprising the steps of:
changing the second predetermined speed and temperature; and
repeating the splicing step, the tapering step, and the lensing step.

6. The method of claim 2, further comprising the steps of:
changing the second predetermined speed and temperature; and
repeating the splicing step, the tapering step, and the lensing step.

7. The method of claim 3, further comprising the step of changing the second predetermined speed and temperature.

8. A tapered fiber with a hemispherical end adapted for MEMS-based switch applications, comprising:
a longitudinal member having a cladding portion and a core portion; and
a tapered member having a cladding portion and a core portion, a ratio of the cladding portion and core portion of the tapered member being uniform, the tapered member having a hemispherical end that is formed by surface tension of molten glass and covered by the molten glass.

9. A system of fabricating a tapered fiber with a hemispherical end adapted for MEMS-based switch applications, comprising:
a pair of filaments;
a pair of fibers disposed in the filaments, respectively, the fibers being spliced into one fiber by heating the filaments, tapered into two tapered fibers by pulling the spliced fiber with a first predetermined speed and temperature, and lensed by setting the tapered fibers back to the heated filaments with a second predetermined speed and temperature so as to form the hemispherical end for each of the tapered fibers.

10. The system of claim 9, wherein each of the tapered fibers has a uniform ratio of cladding portion and core portion.

11. A method of measuring a beam profile of a launching fiber, comprising the steps of:
providing a receiving fiber aligned with the launching fiber;
turning on a light source to send optical beams to the launching fiber;
pulling the receiving fiber away from/toward the launching fiber in a 3D direction; and
detecting received optical beams at the receiving fiber.

12. The method of claim 1, wherein the step of providing the receiving fiber includes a step of providing the receiving fiber having a narrower core than the launching fiber.

13. The method of claim 11, wherein the step of pulling the receiving fiber includes the step of pulling the receiving fiber away from/toward the launching fiber in a horizontal axis, a transversal axis, and a vertical axis, respectively.

14. The method of claim 11, wherein the step of turning the light source includes the step of turning a laser source.

15. A system of measuring a beam profile of a launching fiber, comprising:
a light source to send optical beams to the launching fiber, the launching fiber being coupled to the light source;
a receiving fiber to receive optical beams from the launching fiber, the receiving fiber being disposed aligned with the launching fiber; and
a detector to detect the received optical beams at the receiving fiber while the receiving fiber is being pulled away from/pushed toward the launching fiber in a horizontal axis, a transversal axis, and a vertical axis, respectively.

16. The system of claim 15, wherein the receiving fiber has a narrower core than the launching fiber.

17. A method of fabricating a tapered fiber with a hemispherical end, comprising the steps of:
splicing a fiber by heating the fiber;
tapering the spliced fiber by pulling the spliced fiber with a first predetermined set of parameters to form two tapered fibers; and
lensing the tapered fiber by setting the fiber back to be heated with a second predetermined set of parameters to form a hemispherical end for each of the tapered fiber.

18. The method of claim 17, wherein the first predetermined set of parameters includes speed, distance, and temperature.

19. The method of claim 17, wherein the second predetermined set of parameters includes speed, distance, and temperature.

20. The method of claim 18, wherein the second predetermined set of parameters includes speed, distance, and temperature.
